(19) United States
(12) Patent Application Publication
(10) Pub. No.: US 2026/0223110 A1
(43) Pub. Date: Jul. 30, 2026

(54) BUFFER STATUS REPORTING FOR REDUCED UPLINK PACKET TRANSMISSION LATENCY

(71) Applicant: QUALCOMM Incorporated, San Diego, CA (US)

(72) Inventors: Yuyu YAN, Beijing (CN); Yanzhao SONG, Beijing (CN); Jiaxiang CHANG, Shanghai (CN); Tao YANG, Shanghai (CN); Arnaud MEYLAN, San Diego, CA (US); Arvind Vardarajan SANTHANAM, San Diego, CA (US); Jie MAO, Beijing (CN); Ling XIE, Beijing (CN); Ning ZHAO, Beijing (CN); Xinyu WANG, Beijing (CN); Tom CHIN, San Diego, CA (US); Yuyi LI, Shanghai (CN)

(21) Appl. No.: 19/146,802

(22) PCT Filed: Feb. 24, 2023
(86) PCT No.: PCT/CN2023/078050

§ 371 Date: Jul. 9, 2025

(51) Int. Cl. H04W 72/1268; H04W 72/52

(52) U.S. Cl. CPC H04W 72/1268; H04W 72/52

(57) ABSTRACT

Various aspects of the present disclosure generally relate to wireless communication. In some aspects, a user equipment (UE) may set an uplink traffic medium or high flag. The UE may set a smart buffer status report (BSR) active flag. The UE may perform a slot BSR check by setting a slot BSR check flag and a BSR index, wherein the BSR index is associated with a slot level BSR activation check, and the BSR index is set according to an expected uplink packet size. The UE may transmit, to a network node, a BSR with the BSR index that indicates the expected uplink packet size. The UE may transmit, to the network node, an uplink packet associated with the expected uplink packet size based at least in part on the BSR. Numerous other aspects are described.

### FIELD OF THE DISCLOSURE

Aspects of the present disclosure generally relate to wireless communication and to techniques and apparatuses for buffer status reporting for reduced uplink packet transmission latency.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: determine, by the UE, that a smart buffer status report (BSR) activation precondition is satisfied; set, by the UE, an uplink traffic medium or high flag based at least in part on a quantity of arrived uplink packets in layer 2 (L2); set, by the UE, a smart BSR active flag based at least in part on an average last sequence number (SN) latency in L2 and a padding bit ratio in L2; detect, by the UE, an uplink resource congestion based at least in part on the uplink traffic medium or high flag and the smart BSR active flag; perform, by the UE, a slot BSR check by setting a slot BSR check flag, and a BSR index based at least in part on the slot BSR check flag, the uplink traffic medium or high flag, the smart BSR active flag, and a next available scheduling request (SR) occasion, wherein the BSR index is associated with a slot level BSR activation check, and the BSR index is set according to an expected uplink packet size; transmit, to a network node and based at least in part on the slot BSR check, a BSR with the BSR index that indicates the expected uplink packet size; and transmit, to the network node, an uplink packet associated with the expected uplink packet size based at least in part on the BSR.

In some implementations, a method of wireless communication performed by a UE includes determining, by the UE, that a smart BSR activation precondition is satisfied; setting, by the UE, an uplink traffic medium or high flag based at least in part on a quantity of arrived uplink packets in L2; setting, by the UE, a smart BSR active flag based at least in part on an average last SN latency in L2 and a padding bit ratio in L2; detecting, by the UE, an uplink resource congestion based at least in part on the uplink traffic medium or high flag and the smart BSR active flag; performing, by the UE, a slot BSR check by setting a slot BSR check flag, and a BSR index based at least in part on the slot BSR check flag, the uplink traffic medium or high flag, the smart BSR active flag, and a next available SR occasion, wherein the BSR index is associated with a slot level BSR activation check, and the BSR index is set according to an expected uplink packet size; transmitting, to a network node and based at least in part on the slot BSR check, a BSR with the BSR index that indicates the expected uplink packet size; and transmitting, to the network node, an uplink packet associated with the expected uplink packet size based at least in part on the BSR.

In some implementations, a non-transitory computer-readable medium storing a set of instructions for wireless communication includes one or more instructions that, when executed by one or more processors of a UE, cause the UE to: determine that a smart BSR activation precondition is satisfied; set an uplink traffic medium or high flag based at least in part on a quantity of arrived uplink packets in L2; set a smart BSR active flag based at least in part on an average last SN latency in L2 and a padding bit ratio in L2; detect an uplink resource congestion based at least in part on the uplink traffic medium or high flag and the smart BSR active flag; perform a slot BSR check by setting a slot BSR check flag, and a BSR index based at least in part on the slot BSR check flag, the uplink traffic medium or high flag, the smart BSR active flag, and a next available SR occasion, wherein the BSR index is associated with a slot level BSR activation check, and the BSR index is set according to an expected uplink packet size; transmit, to a network node and based at least in part on the slot BSR check, a BSR with the BSR index that indicates the expected uplink packet size; and transmit, to the network node, an uplink packet associated with the expected uplink packet size based at least in part on the BSR.

In some implementations, an apparatus for wireless communication includes means for determining that a smart BSR activation precondition is satisfied; means for setting an uplink traffic medium or high flag based at least in part on a quantity of arrived uplink packets in L2; means for setting a smart BSR active flag based at least in part on an average last SN latency in L2 and a padding bit ratio in L2; means for detecting an uplink resource congestion based at least in part on the uplink traffic medium or high flag and the smart BSR active flag; means for performing a slot BSR check by setting a slot BSR check flag, and a BSR index based at least in part on the slot BSR check flag, the uplink traffic medium or high flag, the smart BSR active flag, and a next available SR occasion, wherein the BSR index is associated with a slot level BSR activation check, and the BSR index is set according to an expected uplink packet size; means for transmitting, to a network node and based at least in part on the slot BSR check, a BSR with the BSR index that indicates the expected uplink packet size; and means for transmitting, to the network node, an uplink packet associated with the expected uplink packet size based at least in part on the BSR.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4-7 are diagrams illustrating examples associated with buffer status reporting for reduced uplink packet transmission latency, in accordance with the present disclosure.

FIG. 8 is a diagram illustrating an example process associated with buffer status reporting for reduced uplink packet transmission latency, in accordance with the present disclosure.

FIG. 9 is a diagram of an example apparatus for wireless communication, in accordance with the present disclosure.

### DETAILED DESCRIPTION

A gaming application may be latency sensitive. An amount of game latency may depend on a delay from a data arrival to a next available scheduling request (SR) occasion. In a network deployment, an SR period may be configured in accordance with an SR configuration. When the SR period is larger than 10 ms, an average delay from the high data arrival to the next available SR occasion may be non-negligible. When the UE has gaming data to transmit, the UE may be unable to immediately transmit an SR due to relatively infrequent SR occasions.

The amount of game latency may also depend on an uplink game packet split delay. In some cases, one uplink game packet may be split into two or more parts, and thereby may be associated with two or more physical uplink shared channels (PUSCHs). The one uplink game packet may be split when a first uplink grant transport block (TB) size is too small for the entire uplink game packet. Due to a network scheduling behavior, after a network node receives the SR, the network node may transmit a first uplink grant with a relatively small TB size to obtain buffer status information. The UE may transmit, to the network node, a BSR together with a first PUSCH. Based at least in part on the BSR received from the UE, the network node may transmit a second uplink grant, and residual buffer information may be transmitted by the UE via a second PUSCH.

In some aspects described herein, a user equipment (UE) may determine that a smart buffer status report (BSR) activation precondition is satisfied. The UE may set an uplink traffic medium or high flag based at least in part on a quantity of arrived uplink packets in layer 2 (L2). The UE may set a smart BSR active flag based at least in part on an average last sequence number (SN) latency in L2 and a padding bit ratio in L2. The UE may detect an uplink resource congestion based at least in part on the uplink traffic medium or high flag and the smart BSR active flag. The UE may perform a slot BSR check by setting a slot BSR check flag, and a BSR index based at least in part on the slot BSR check flag, the uplink traffic medium or high flag, the smart BSR active flag, and a next available SR occasion. The BSR index may be associated with a slot level BSR activation check. The BSR index may be set according to an expected uplink packet size. As part of the slot BSR check, the UE may transmit an SR to a network node. The UE may transmit the SR at the next available SR occasion in order to request an uplink resource from the network node. The UE may transmit, to the network node and based at least in part on the slot BSR check, a BSR with the BSR index that indicates the expected uplink packet size. The UE may transmit, to the network node, an uplink packet associated with the expected uplink packet size. The UE may be able to transmit the uplink packet based at least in part on the SR and the BSR. The UE may be able to transmit the uplink packet with a reduced latency because the UE already transmitted the SR and the BSR. The reduced latency may improve a performance of the UE, especially when the uplink packet is associated with a low latency application (e.g., a gaming application) that runs on the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

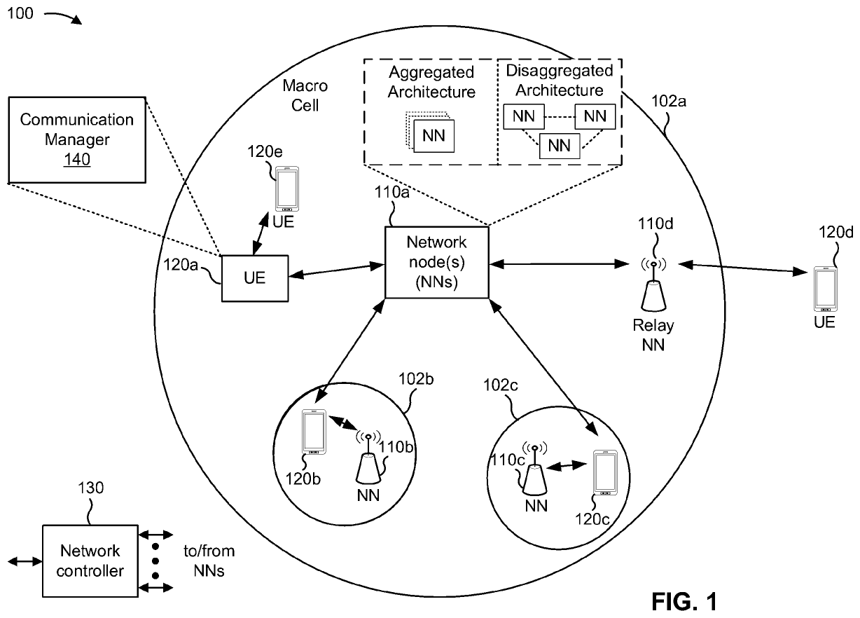

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may determine that a smart BSR activation precondition is satisfied; set an uplink traffic medium or high flag based at least in part on a quantity of arrived uplink packets in L2; set a smart BSR active flag based at least in part on an average last SN latency in L2 and a padding bit ratio in L2; detect an uplink resource congestion based at least in part on the uplink traffic medium or high flag and the smart BSR active flag; perform a slot BSR check by setting a slot BSR check flag, and a BSR index based at least in part on the slot BSR check flag, the uplink traffic medium or high flag, the smart BSR active flag, and a next available SR occasion, wherein the BSR index is associated with a slot level BSR activation check, and the BSR index is set according to an expected uplink packet size; transmit, to a network node and based at least in part on the slot BSR check, a BSR with the BSR index that indicates the expected uplink packet size; and transmit, to the network node, an uplink packet associated with the expected uplink packet size based at least in part on the BSR. Additionally, or alternatively, the communication manager 140 may perform one or more other operations described herein.

As indicated above, FIG. 1 is provided as an example. Other examples may differ from what is described with regard to FIG. 1.

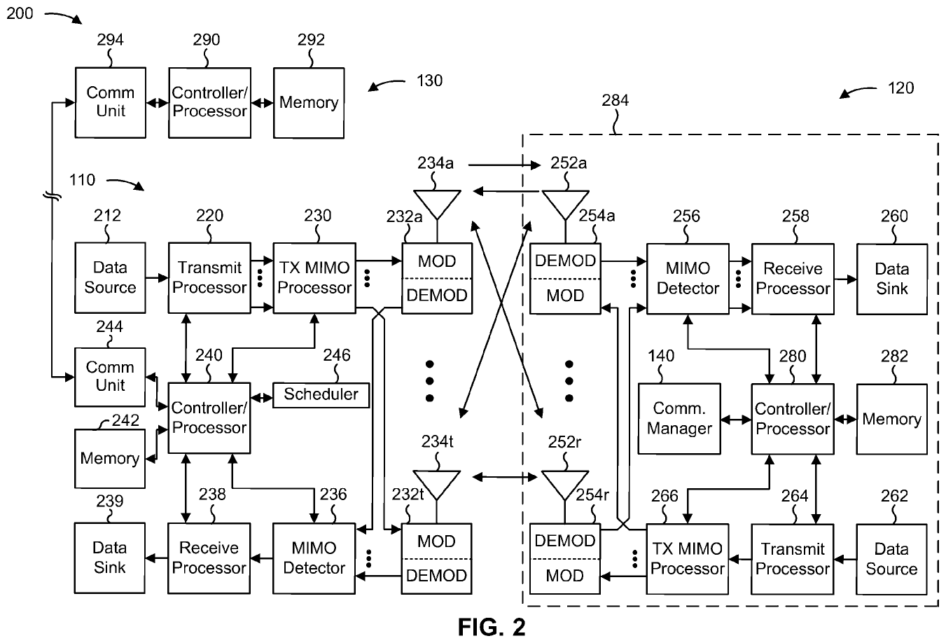

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

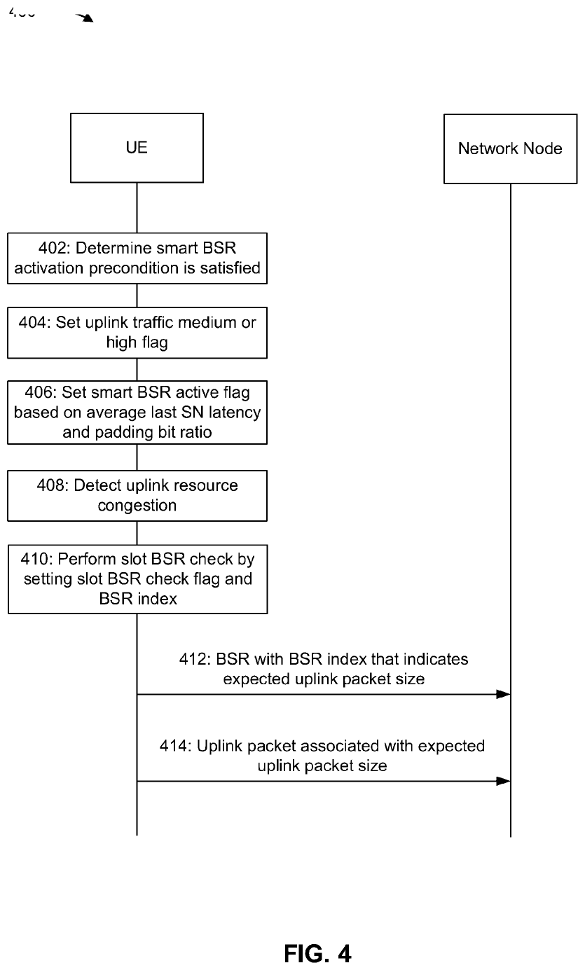

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

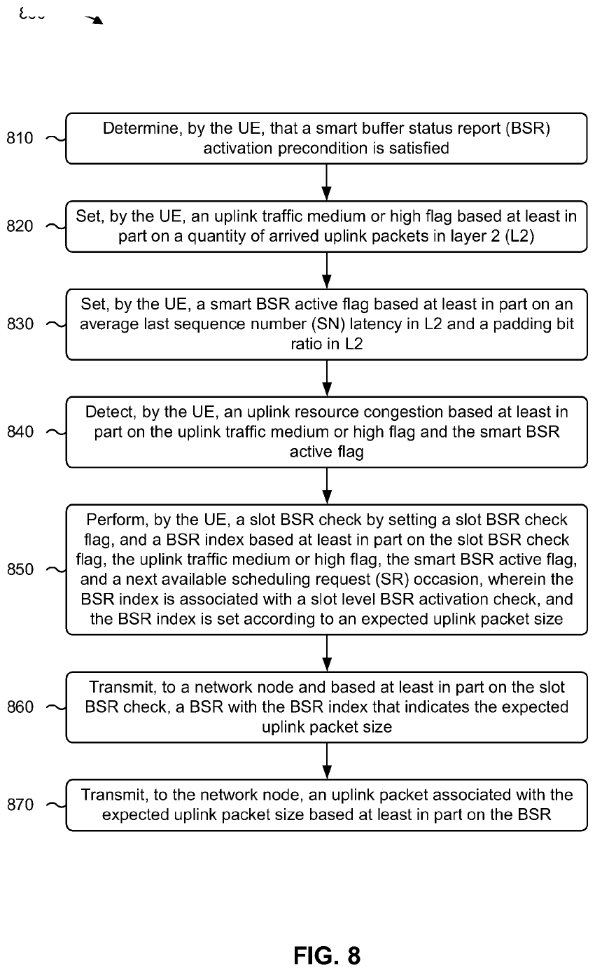

The controller/processor 240 of the network node 110, the controller/processor 280 of the UE 120, and/or any other component(s) of FIG. 2 may perform one or more techniques associated with buffer status reporting for reduced uplink packet transmission latency, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, a UE (e.g., the UE 120) includes means for determining, by the UE, that a smart BSR activation precondition is satisfied; means for setting, by the UE, an uplink traffic medium or high flag based at least in part on a quantity of arrived uplink packets in L2; means for setting, by the UE, a smart BSR active flag based at least in part on an average last SN latency in L2 and a padding bit ratio in L2; means for detecting, by the UE, an uplink resource congestion based at least in part on the uplink traffic medium or high flag and the smart BSR active flag; means for performing, by the UE, a slot BSR check by setting a slot BSR check flag, and a BSR index based at least in part on the slot BSR check flag, the uplink traffic medium or high flag, the smart BSR active flag, and a next available SR occasion, wherein the BSR index is associated with a slot level BSR activation check, and the BSR index is set according to an expected uplink packet size; means for transmitting, to a network node and based at least in part on the slot BSR check, a BSR with the BSR index that indicates the expected uplink packet size; and/or means for transmitting, to the network node, an uplink packet associated with the expected uplink packet size based at least in part on the BSR. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

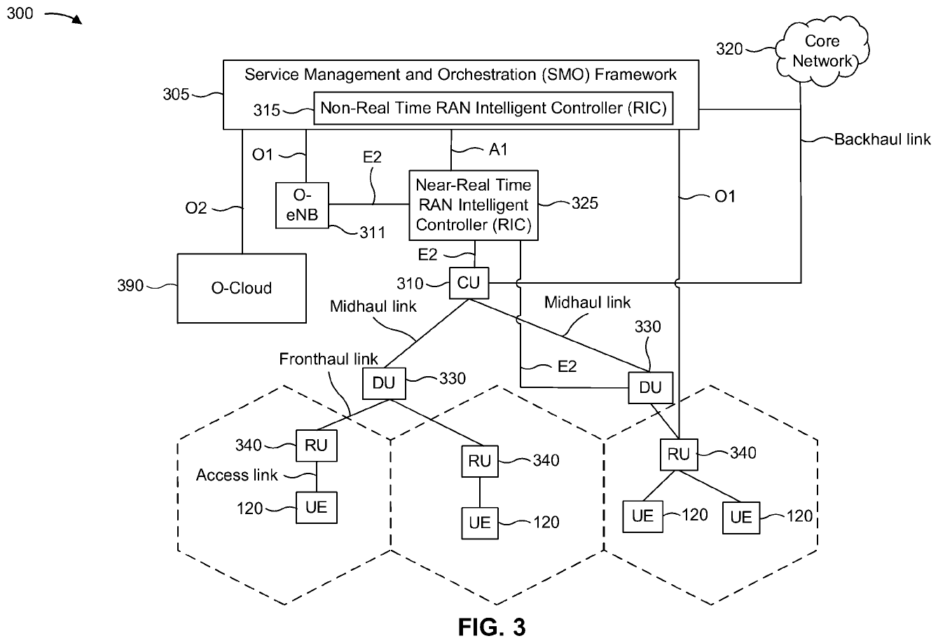

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

In a gaming application, an uplink/downlink game traffic pattern may vary under different game scenarios. As an example, a game scenario involving no action (e.g., no screen touch event) may be associated with an uplink packet frequency of three uplink packets per second, an uplink packet size of 144 bytes, a downlink packet frequency of every 66 ms, a downlink packet size of 133 bytes (e.g., every 300 to 330 ms), and a rare occurrence during a game. A game scenario involving checking a virtual map or a status of other players may be associated with an uplink packet frequency of three to six uplink packets per second, an uplink packet size of 144 bytes, a downlink packet frequency of every 66 ms, a downlink packet size of 133 bytes (e.g., every 300 to 330 ms), and an occurrence during the game that depends on a player level. A game scenario involving moving a virtual avatar (move only) may be associated with an uplink packet frequency of 10 to 20 user packets per second, an uplink packet size of 144 bytes, a downlink packet frequency of every 66 ms, a downlink packet size of 133 bytes (every second), and a common occurrence during the game. A game scenario involving moving a virtual avatar and performing an attack with the virtual avatar (move and attack) may be associated with an uplink packet frequency of 30 to 40 packets per second, an uplink packet size of 144 bytes, a downlink packet frequency of every 66 ms, a downlink packet size of 133 bytes (every second), and a frequent occurrence during the game. An uplink packet size may be up to 144 bytes (e.g., a user datagram protocol (UDP) packet size) with different packet arrival intervals from 330 ms to 25 ms. Further, relatively high game latency in game scenarios involving moving the virtual avatar and/or performing the attack with the avatar may have a relatively large impact on a UE game experience.

Different gaming applications may be associated with different uplink packet statistics in an L2. An uplink packet size with a relatively high distribution may range from 45 bytes to 158 bytes. An uplink packet number range in one second may depend on a game scenario, but may vary between 4 and 120.

A gaming application may be latency sensitive. An amount of game latency may depend on a delay from high data arrival to a next available SR occasion. In a network deployment, an SR period may be configured in accordance with an SR configuration. When the SR period is larger than 10 ms, an average delay from the high data arrival to the next available SR occasion may be non-negligible. When the UE has gaming data to transmit, the UE may be unable to immediately transmit an SR due to relatively infrequent SR occasions.

The amount of game latency may also depend on an uplink game packet split delay. In some cases, one uplink game packet may be split into two or more parts, and thereby may be associated with two or more physical uplink shared channels (PUSCHs). The one uplink game packet may be split when a first uplink grant transport block (TB) size is too small for the entire uplink game packet. Due to a network scheduling behavior, after a network node receives the SR, the network node may transmit a first uplink grant with a relatively small TB size to obtain buffer status information. The UE may transmit, to the network node, a BSR together with a first PUSCH. Based at least in part on the BSR received from the UE, the network node may transmit a second uplink grant, and residual buffer information may be transmitted by the UE via a second PUSCH. A time interval between the first uplink grant and the second uplink grant may be approximately 5 ms under a typical time division duplexing (TDD) configuration of “DDDDDDDSUU” (where “D” is a downlink subframe, “U” is an uplink subframe, and “S” is a special subframe) and a subcarrier spacing (SCS) of 30 kHz and may be shorter in a frequency division duplexing (FDD) configuration.

In various aspects of techniques and apparatuses described herein, a UE may determine that a smart BSR activation precondition is satisfied. The UE may set an uplink traffic medium or high flag based at least in part on a quantity of arrived uplink packets in L2. The UE may set a smart BSR active flag based at least in part on an average last SN latency in L2 and a padding bit ratio in L2. The UE may detect an uplink resource congestion based at least in part on the uplink traffic medium or high flag and the smart BSR active flag. The UE may perform a slot BSR check by setting a slot BSR check flag, and a BSR index based at least in part on the slot BSR check flag, the uplink traffic medium or high flag, the smart BSR active flag, and a next available SR occasion. The BSR index may be associated with a slot level BSR activation check. The BSR index may be set according to an expected uplink packet size. As part of the slot BSR check, the UE may transmit an SR to a network node. The UE may transmit the SR at the next available SR occasion in order to request an uplink resource from the network node. The UE may transmit, to the network node and based at least in part on the slot BSR check, a BSR with the BSR index that indicates the expected uplink packet size. The UE may transmit, to the network node, an uplink packet associated with the expected uplink packet size. The UE may be able to transmit the uplink packet based at least in part on the SR and the BSR. The UE may be able to transmit the uplink packet with a reduced latency because the UE already transmitted the SR and the BSR. The reduced latency may improve a performance of the UE, especially when the uplink packet is associated with a low latency application (e.g., a gaming application) that runs on the UE.

FIG. 4 is a diagram illustrating an example 400 associated with buffer status reporting for reduced uplink packet transmission latency, in accordance with the present disclosure. As shown in FIG. 4, example 400 includes communication between a UE (e.g., UE 120) and a network node (e.g., network node 110). In some aspects, the UE and the network node may be included in a wireless network, such as wireless network 100.

As shown by reference number 402, the UE may determine that a smart BSR activation precondition is satisfied. The smart BSR activation precondition may be satisfied based at least in part on a low latency mode being enabled and a game accelerator being turned on. The low latency mode and the game accelerator may be associated with an application layer of the UE. The low latency mode may be a 5G Low Latency Mode.

In some aspects, a smart BSR algorithm may reduce a gaming application latency under the low latency mode. In a first step of the smart BSR algorithm, the UE may determine whether the smart BSR activation precondition is satisfied. The UE may determine whether the low latency mode is enabled and whether the game accelerator is turned on, which may satisfy the smart BSR activation precondition. The game accelerator may be included in a game auto setup in the application layer of the UE.

As shown by reference number 404, the UE may set an uplink traffic medium or high flag based at least in part on a quantity of arrived uplink packets in L2. The UE may initialize the uplink traffic medium or high flag to false. The UE may count the quantity of arrived uplink packets in L2 in a monitor window. The quantity of arrived uplink packets L2 may be associated with a gaming application. The UE may set the uplink traffic medium or high flag to true when the quantity of arrived uplink packets in L2 is greater than a first threshold. The UE may set the uplink traffic medium or high flag to false when the quantity of arrived uplink packets in L2 in a quantity of consecutive monitor windows is less than a second threshold. The UE may output the uplink traffic medium or high flag.

In some aspects, in a second step of the smart BSR algorithm, the UE may detect whether uplink traffic is medium or high based at least in part on the quantity of arrived uplink packets in L2. The UE may initialize an uplink traffic medium or high (UL_traffic_medium_or_high) flag to false. The UL_traffic_medium_or_high flag may be an uplink traffic load indication, which may be associated with a particular game scenario (e.g., move only, or move and attack). The UE may define the monitor window, such as a one second monitor window. In each monitor window, the UE may count a quantity of uplink packets (UL_Packet_Num) arrived in L2 with a priority indicator (e.g., PrioQ “LL1”). Uplink gaming packets in the low latency mode may be tagged with the priority indicator. The UL_Packet_Num may be updated per second. When the UL_Packet_Num is greater than an uplink traffic medium threshold (UL_traffic_medium_threshold) (e.g., set to a default value of 12), the UE may set the UL_traffic_medium_or_high flag to true. When the UL_Packet_Num is less than an uplink traffic low threshold (UL_traffic_low_threshold) (e.g., set to a default value of default 10) in a quantity of consecutive monitor windows (e.g., the quantity may be defined by N_UL_traffic_confirm, which may be set to a default value of 3), the UE may set the UL_traffic_medium_or_high flag to false. Otherwise, no change may occur to the UL_traffic_medium_or_high flag. The UE may output the UL_traffic_medium_or_high flag (e.g., true or false). The UE may update the UL_traffic_medium_or_high flag per second.

As shown by reference number 406, the UE may set a smart BSR active flag based at least in part on an average last SN latency in L2 and a padding bit ratio in L2. The UE may initialize the smart BSR active flag to false. The smart BSR active flag may be associated with an ability to report additional buffer status information to the network node. The UE may determine the average last SN latency in L2 in a monitor window based at least in part on the uplink traffic medium or high flag and the smart BSR active flag. The average last SN latency in L2 may be updated in accordance with an update interval. The UE may determine the padding bit ratio in L2 in the monitor window based at least in part on the uplink traffic medium or high flag and the smart BSR active flag. The padding bit ratio in L2 may be updated in accordance with the update interval. The UE may determine whether the average last SN latency in L2 is greater than a last SN latency threshold, the padding bit ratio in L2 is less than a padding ratio threshold, and/or the padding bit ratio in L2 is less than a padding ratio limit. The UE may set the smart BSR active flag to true when the average last SN latency in L2 is greater than the last SN latency threshold, the padding bit ratio in L2 is less than the padding ratio threshold, and the padding bit ratio in L2 is less than the padding ratio limit. The UE may set the smart BSR active flag to false when the average last SN latency in L2 is not greater than the last SN latency threshold, the padding bit ratio in L2 is not less than the padding ratio threshold, and/or the padding bit ratio in L2 is not less than the padding ratio limit. The UE may output the smart BSR active flag.

In some aspects, in a third step of the smart BSR algorithm, the UE may detect whether a smart BSR is active (smart_BSR_active). The UE may define the smart_BSR_active flag, which may indicate whether an additional BSR is to be reported to the network node. The additional BSR may be in addition to an actual BSR. The UE may initialize the smart_BSR_active flag to false.

In some aspects, in the third step of the smart BSR algorithm, the UE may perform an average last SN latency check. The UE may calculate the average last SN latency (avg_last_SN_latency_xx) in L2 with the priority indicator associated with high data arrival per monitor window. A first packet of the high data arrival may be associated with a start time, a last packet of the same SN that is transmitted may be associated with an end time, and a last SN latency may be a difference between the start time and the end time. A window size may be defined by a win_smart_BSR_check*M parameter. The UE may count the average last SN latency as avg_last_SN_latency_enable and a first M value (e.g., M=1) when the UL_traffic_medium_or_high flag is set to true and when the smart_BSR_active flag is set to true. Otherwise, the UE may count the average last SN latency as avg_last_SN_latency_baseline (a baseline value) and a second M value (e.g., M=5). The UE may update the avg_last_SN_latency_xx per win_smart_BSR_check*M ms, where M is a selected value. In other words, the UE may calculate the avg_last_SN_latency_xx in L2 with the priority indicator in each monitor window, and an update interval may be win_smart_BSR_check*M ms.

In some aspects, in the third step of the smart BSR algorithm, the UE may also perform a padding bit ratio check. The UE may calculate the padding bit ratio (padding_bit_ratio_xx) in L2 with the priority indicator per monitor window, where the window size may be defined by the win_smart_BSR_check*M parameter. The padding bit ratio may depend on an uplink grant size in relation to an uplink data size, where the uplink grant size may contain additional bits as compared to the uplink data size. The UE may count the padding bit ratio as padding_ratio_enable and a first M value (e.g., M=1) when the UL_traffic_medium_or_high flag is set to true and when the smart_BSR_active flag is set to true. Otherwise, the UE may count the padding bit ratio as padding_ratio_baseline (a baseline value) and a second M value (e.g., M=5). The UE may update the padding_bit_ratio_xx per win_smart_BSR_check*M ms, where M is a selected value. In other words, the UE may calculate the padding_bit_ratio_xx in L2 with the priority indicator in each monitor window, and an update interval may be win_smart_BSR_check*M ms.

In some aspects, when the avg_last_SN_latency is greater than a last SN latency threshold (last_SN_latency_threshold), and a difference between a padding_ratio_enable value and a padding_ratio_baseline value is less than a padding bit ratio threshold (padding_ratio_threshold), and the padding_ratio_enable value is less than a padding ratio limit (padding_ratio_limit), the UE may set the smart_BSR_active flag to true. Otherwise, the UE may set the smart_BSR_active flag to false. The UE may output the smart_BSR_active flag. Further, the UE may update the smart_BSR_active flag in accordance with an update interval of win_smart_BSR_check ms.

As shown by reference number 408, the UE may detect an uplink resource congestion based at least in part on the uplink traffic medium or high flag and the smart BSR active flag. The UE may set the smart BSR active flag to false for a duration of time when the average last SN latency in L2 is less than an average last SN latency baseline plus a time period. The UE may set the smart BSR active flag to false when the average last SN latency in L2 is less than the average last SN latency baseline plus a time period in multiple instances.

In some aspects, in a fourth step of the smart BSR algorithm, the UE may detect the uplink resource congestion. When the UL_traffic_medium_or_high flag is true and the smart_BSR_active flag is true, and when the UE detects one time that an avg_last_SN_latency_enable is greater than avg_last_SN_latency_baseline+bias (e.g., avg_last_SN_latency_baseline+10 ms) in a current cell, the UE may force the smart_BSR_active flag to be false for a certain time duration (e.g., 5 mins+randon (1)*10 mins). When the UE detects two times that the avg_last_SN_latency_enable is greater than the avg_last_SN_latency_baseline+bias in the current cell, the UE may force the smart_BSR_active flag to be false for the current cell.

As shown by reference number 410, the UE may perform a slot BSR check by setting a slot BSR check flag. The UE may also perform the slot BSR check by setting a BSR index based at least in part on the slot BSR check flag, the uplink traffic medium or high flag, the smart BSR active flag, and a next available SR occasion. The BSR index may be associated with a slot level BSR activation check. The BSR index may be set according to an expected uplink packet size. The expected uplink packet size may be an adaptive size that is based at least in part on a distribution of uplink packet size in L2 in a last time duration. The expected uplink packet size may not exceed a defined limit.

In some aspects, the BSR index may be an adaptive value that is based at least in part on a highest distribution of an uplink packet size from a previous defined monitor window. The BSR index may change per monitor window. The BSR index may be defined based at least in part on a packet size mapping, which may be further defined, for example, in 3GPP Technical Specification (TS) 38.321 Section 6.1.3.1 Release 17.

In some aspects, when performing the slot BSR check, the UE may initialize the slot BSR check flag to true. The UE may set the slot BSR check flag to false based at least in part on an uplink packet being sent. No additional BSR index may be sent when the slot BSR check flag is set to false.

In some aspects, when performing the slot BSR check, the UE may identify that the next available SR occasion occurs in less than a first time value. The UE may transmit, for an expected uplink packet in accordance with an uplink packet distribution, an SR at the next available SR occasion nearest to the first time value. The UE may set the slot BSR check flag to true after the SR is triggered. The UE may set the slot BSR check flag to false when the expected uplink packet is sent.

In some aspects, when performing the slot BSR check, the UE may identify that the next available SR occasion occurs in greater than a first time value and in less than a second time value. The UE may transmit, for an expected uplink packet in accordance with an uplink packet distribution, an SR at the next available SR occasion nearest to the second time value. The UE may set the slot BSR check flag to true after the SR is triggered. The UE may set the slot BSR check flag to false when the expected uplink packet is sent.

In some aspects, when performing the slot BSR check, the UE may identify that the next available SR occasion occurs in greater than a second time value and in less than a third time value. The UE may set the slot BSR check flag to true for a first time period based at least in part on the next available SR occasion occurring in greater than the second time value and in less than the third time value. The UE may set the slot BSR check flag to false when an uplink packet is sent during the first time period. The UE may transmit, for an expected uplink packet in accordance with an uplink packet distribution, an SR at the next available SR occasion nearest to the third time value when the uplink packet is not sent. The UE may set the slot BSR check flag to true after the SR is triggered. The UE may set the slot BSR check flag to false when the expected uplink packet is sent.

In some aspects, when performing the slot BSR check, the UE may identify that the next available SR occasion occurs in greater than a third time value and in less than a fourth time value. The UE may set the slot BSR check flag to true for a first time period based at least in part on the next available SR occasion occurring in greater than the third time value and in less than the fourth time value. The UE may set the slot BSR check flag to false when an uplink packet is sent during the first time period. The UE may transmit, for an expected uplink packet in accordance with an uplink packet distribution, an SR at the next available SR occasion nearest to the third time value when the uplink packet is not sent. The UE may set the slot BSR check flag to true after the SR is triggered. The UE may set the slot BSR check flag to false when the expected uplink packet is sent.

In some aspects, when performing the slot BSR check, the UE may identify that the next available SR occasion occurs in greater than a fourth time value. The UE may set the slot BSR check flag to true for a second time period based at least in part on the next available SR occasion that occurs in greater than the fourth time value. The UE may set the slot BSR check flag to false when an uplink packet is sent during the second time period. The UE may transmit, for an expected uplink packet in accordance with an uplink packet distribution, an SR at the next available SR occasion when the uplink packet is not sent. The UE may set the slot BSR check flag to true after the SR is triggered. The UE may set the slot BSR check flag to false when the expected uplink packet is sent.

In some aspects, in a fifth step of the smart BSR algorithm, the UE may set a proper BSR index. When the UL_traffic_medium_or_high flag is set to true and when the smart_BSR_active flag is set to true, and when the high data arrival is present and the BSR index is updated accordingly (e.g., a BSR index is greater than zero), then the UE may make no further adjustment to the BSR index. Otherwise, when a slot level BSR check (slot_BSR_check) flag is set to true, the UE may set the BSR index according to the expected uplink packet size (e.g., expected game uplink packet size). The expected uplink packet size may be adaptive. The expected uplink packet size may be based at least in part on a highest distribution of uplink packet size (arrived in L2 with the priority indicator) in a recent win_UL_packet_size_monitor seconds. An upper limit of the expected uplink packet size may not exceed an expected_UL_packet_size_limit to avoid resource waste.

In some aspects, in a slot level BSR check procedure, the UE may initialize the slot_BSR_check flag to true. When an uplink packet tagged with a priority indicator is sent out, the UE may set the slot_BSR_check flag to false, which may mean that the UE does not set the BSR index according to the expected uplink packet size.

When a next available SR occasion is in less than a first time value (e.g., 9 ms), the UE may trigger an SR at an SR occasion nearest to the first time value. The UE may trigger the SR at the SR occasion to prepare for a next uplink packet, even though the uplink packet may not have actually arrived yet. The UE may set the slot_BSR_check flag to true after the SR is triggered. When the uplink packet is sent out, the UE may set to slot_BSR_check flag to false.

When the next available SR occasion is in greater than the first time value and less than or equal to a second time value (e.g., 14 ms), the UE may trigger the SR at the SR occasion nearest to the second time value. The UE may set the slot_BSR_check flag to true after the SR is triggered. When the uplink packet is sent out, the UE may set the slot_BSR_check flag to false.

When the next available SR occasion is in greater than the second time value and less than or equal to a third time value (e.g., 19 ms), the UE may set the slot_BSR_check flag to true for a first time period (e.g., 5 ms). When the uplink packet is sent out during the first time period, the UE may set the slot_BSR_check flag to false. Otherwise, the UE may trigger the SR at the SR occasion nearest to the third time value. The UE may set the slot_BSR_check flag to true after the SR is triggered, and when the uplink packet is sent out, the UE may set the slot_BSR_check flag to false.

When the next available SR occasion is in greater than the third time value and less than or equal to a fourth time value (e.g., 29 ms), the UE may set the slot_BSR_check flag to true for the first time period. When the uplink packet is sent out during the first time period, the UE may set the slot_BSR_check flag to false. Otherwise, the UE may trigger the SR at the SR occasion nearest to the fourth time value. The UE may set the slot_BSR_check flag to true after the SR is triggered, and when the uplink packet is sent out, the UE may set the slot_BSR_check flag to false.

When the next available SR occasion is in greater than the fourth time value, the UE may set the slot_BSR_check flag to true for a second time period (e.g., 10 ms). When the uplink packet is sent out during the first time period, the UE may set the slot_BSR_check flag to false. Otherwise, the UE may trigger the SR at a nearest SR occasion. The UE may set the slot_BSR_check flag to true after the SR is triggered, and when the uplink packet is sent out, the UE may set the slot_BSR_check flag to false.

As shown by reference number 412, the UE may transmit, to the network node and based at least in part on the slot BSR check, a BSR with the BSR index that indicates the expected uplink packet size. The UE may transmit the SR, and then the UE may transmit the BSR to indicate the expected uplink packet size. The SR may be triggered in anticipation of an expected uplink packet, and then the BSR with the BSR index may be transmitted to indicate the expected uplink packet size. The network node may grant uplink resources of appropriate size based at least in part on the SR and the BSR received from the UE.

As shown by reference number 414, the UE may transmit, to the network node, an uplink packet associated with the expected uplink packet size based at least in part on the BSR. For example, when the uplink packet actually arrives, the UE may immediately transmit the uplink packet via a PUSCH because the SR and the BSR have already been transmitted in anticipation of the uplink packet. The uplink packet may be transmitted with reduced latency because the SR and the BSR have already been transmitted in anticipation of the uplink packet. The UE may transmit the SR for a first uplink grant, and then the UE may transmit the BSR in a medium access control control element (MAC-CE) associated with a first PUSCH, and so on. When the UE keeps transmitting BSRs, the UE may not need to transmit an SR again.

In some aspects, the BSR may be “smart” because the BSR may indicate the expected uplink packet size, whereas a typical BSR may be based at least in part on data that has already arrived (e.g., not for data that is anticipated but rather for an actual packet data arrival). Further, the BSR may be “smart” because the BSR may determine when to send an additional BSR to the network node. In other words, the BSR may involve transmitting the additional BSR when the UE predicts that another uplink packet will be arriving, which may be based on an uplink packet distribution. For example, the UE may expect that another uplink packet will be arriving in 10 ms, so the UE may proactively transmit the BSR for this expected uplink packet.

In some aspects, the smart BSR may be based at least in part on real-time needs, and may balance optimization gain and side effect mitigation. An uplink packet density check (second step) may exclude a low uplink traffic scenario. An SN latency check (third step) may exclude a pre-scheduling and a low SR period scenario. A padding ratio check (also third step) may stop additional BSRs when an increased padding radio exceeds a threshold. An uplink resource congestion detection (fourth step) may disable the smart BSR for a certain time period after a first detection, and may disable the smart BSR altogether after a second detection. A slot level additional BSR on/off check may take into account the next available SR occasion (fifth step), which may further reduce additional BSRs. With such checking and detection mechanisms, the smart BSR may reduce network uplink resource waste and avoid network congestion.

In some aspects, the smart BSR may allow the uplink packet (e.g., an uplink game packet) to be sent out once after arrival. The UE may not need to wait until the next available SR occasion to request an uplink grant from a network node. With the BSR index, which may be adjusted based at least in part on the expected uplink packet size, one PUSCH may be able to transmit one uplink packet without having a packet split delay. The smart BSR may lead to an increased uplink scheduling rate, which may increase a power consumption of the UE.

As indicated above, FIG. 4 is provided as an example. Other examples may differ from what is described with regard to FIG. 4.

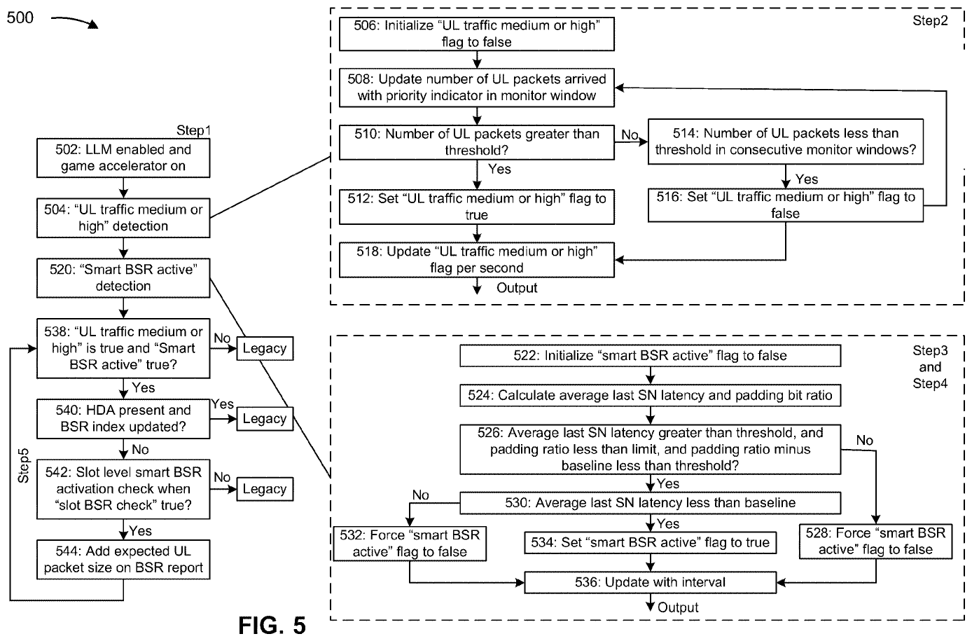

FIG. 5 is a diagram illustrating an example 500 associated with buffer status reporting for reduced uplink packet transmission latency, in accordance with the present disclosure.

As shown by reference number 502, a UE may determine that a low latency mode is enabled and that a game accelerator is turned on. The low latency mode may be a 5G Low Latency Mode. As shown by reference number 504, the UE may perform a UL_traffic_medium_or_high detection. As shown by reference number 506, the UE may initialize an UL_traffic_medium_or_high flag to false. As shown by reference number 508, the UE may update an UL_Packet_Num arrived in L1 with a priority indicator in each monitor window (e.g., one second). As shown by reference number 510, the UE may determine whether the UL_Packet_Num is greater than a UL_traffic_medium_threshold, and if yes, as shown by reference number 512, the UE may set the UL_traffic_medium_or_high flag to true. When the UL_Packet_Num is not greater than the UL_traffic_medium_threshold, as shown by reference number 514, the UE may determine whether the UL_Packet_Num is less than an UL_traffic_low_threshold in N_UL_traffic_confirm consecutive monitor windows. When the UL_Packet_Num is less than the UL_traffic_low_threshold in the N_UL_traffic_confirm consecutive monitor windows, as shown by reference number 516, the UE may set the UL_traffic_medium_or_high flag to false. As shown by reference number 518, the UE may update the UL_traffic_medium_or_high flag every one second and provide an output.

As shown by reference number 520, the UE may perform a smart_BSR_active detection. As shown by reference number 522, the UE may initialize a smart_BSR_active flag to false. As shown by reference number 524, the UE may calculate an avg_last_SN_latency in L2 with a priority indicator in each monitor window, where an update interval may be win_smart_BSR_check*M ms. The UE may calculate a padding_bit_ratio in L2 with the priority indicator in each monitor window, where the update interval may be win_smart_BSR_check*M ms. As shown by reference number 526, the UE may determine whether an avg_last_SN_latency is greater than a last_SN_latency_threshold, and a padding_ratio_enable is less than a padding_ratio_limit, and a difference between a padding_ratio_enable and a padding_ratio_baseline is less than a padding_ratio_threshold, and if no, as shown by reference number 528, the UE may set the smart_BSR_active flag to false, and if yes, as shown by reference number 530, the UE may determine whether an avg_last_SN_latency_enable is greater than an avg_last_SN_latency_baseline+10 ms. If no, as shown by reference number 532, the UE may force the smart_BSR_active flag to be false for 5 mins+randon (1)*10 mins, and if yes, as shown by reference number 534, the UE may set the smart_BSR_active flag to true. As shown by reference number 536, the UE may update the smart_BSR_active flag using a win_smart_BSR_check ms interval, and may provide an output.

As shown by reference number 538, the UE may determine whether the UL_traffic_medium_or_high flag is true and the smart_BSR_active flag is true, and if no, the UE may perform a legacy operation. When yes, as shown by reference number 540, the UE may determine whether high data arrival is present and whether a BSR index is updated accordingly (e.g., BSR index is greater than zero), and if yes, the UE may perform a legacy operation. When no, as shown by reference number 542, the UE may perform a slot level smart BSR activation check when a slot_BSR_check flag is true. When the slot_BSR_check flag is not true, the UE may perform a legacy operation. When the slot_BSR_check flag is true, as shown by reference number 544, the UE may add an expected uplink packet size to a BSR transmitted to a network node, which may reduce an uplink packet transmission latency.

As indicated above, FIG. 5 is provided as an example. Other examples may differ from what is described with regard to FIG. 5.

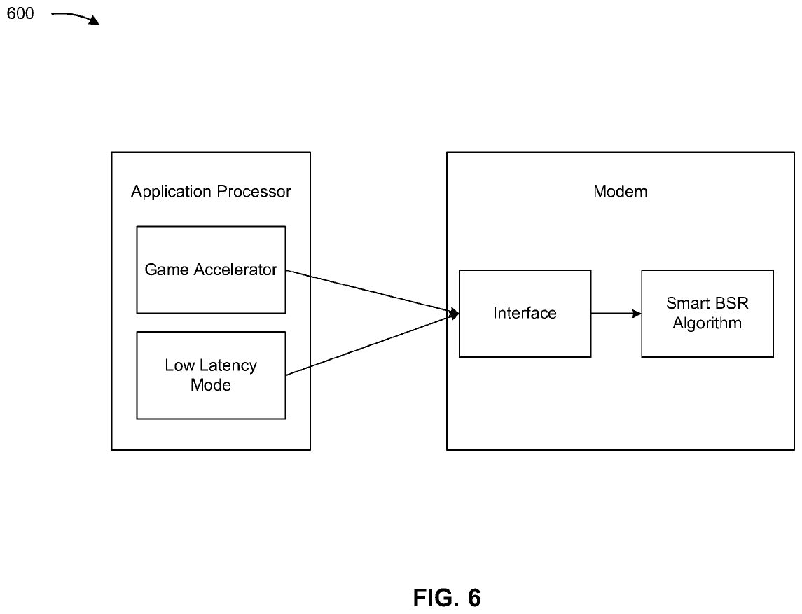

FIG. 6 is a diagram illustrating an example 600 associated with buffer status reporting for reduced uplink packet transmission latency, in accordance with the present disclosure.

As shown in FIG. 6, a smart BSR function may be enabled when a low latency mode and a game accelerator are turned on. The low latency mode and the game accelerator may be associated with an application layer. The low latency mode may be a 5G Low Latency Mode. The low latency mode and the game accelerator may be associated with an interface of a modem. The interface may be associated with hardware and software of the modem that run the smart BSR function.

As indicated above, FIG. 6 is provided as an example. Other examples may differ from what is described with regard to FIG. 6.

In some aspects, a UE may transmit, to a network node, UE assistance information (UAI) to request additional uplink layers and a larger bandwidth based at least in part on an uplink grant size. The UAI may be transmitted based at least in part on a previous reduction in uplink layers, a UE sounding on one sounding reference signal (SRS) port to induce one layer uplink grants, or a bandwidth part (BWP) associated with the UE whose bandwidth is less than a BWP threshold and one uplink layer being supported.

In some aspects, the UE may transmit, to the network node, the UAI to request the additional uplink layers and the larger bandwidth, for example, when the uplink grant size is relatively small (e.g., a relatively high avg_last_SN_latency due to a relatively small uplink grant size). The UE may transmit the UAI to request the additional uplink layers and the larger bandwidth when the UE has sent UAI to reduce the uplink layers, or when the UE is sounding on one SRS port to induce one-layer uplink grants. The UE may transmit the UAI to request the additional uplink layers and the larger bandwidth when in a low latency mode. Further, the UE may transmit the UAI to request the additional uplink layers and the larger bandwidth in the low latency mode when the UE is in a relatively small BWP and only one uplink layer is supported.

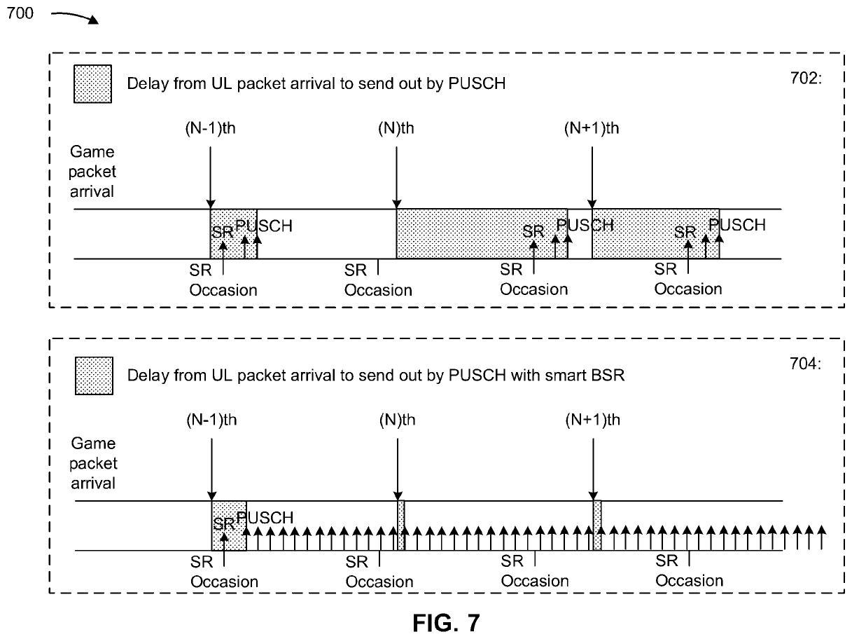

FIG. 7 is a diagram illustrating an example 700 associated with buffer status reporting for reduced uplink packet transmission latency, in accordance with the present disclosure.

As shown by reference number 702, a first ((N−1)th) uplink game packet may arrive at a first time. After a next SR occasion, a UE may transmit the first uplink game packet via a PUSCH. The first uplink game packet may be associated with a first delay. A second ((N)th) uplink game packet may arrive at a second time. The second uplink game packet may arrive after an SR occasion, so the UE may need to wait until a next SR occasion, after which the UE may transmit the second uplink game packet via a PUSCH. The second uplink game packet may be associated with a second delay. A third ((N+1)th) uplink game packet may arrive at a third time. After a next SR occasion, the UE may transmit the third uplink game packet via a PUSCH. The third uplink game packet may be associated with a third delay. In these cases, the game packets may arrive at any time, but the UE may need to wait until a next available SR occasion before the UE is able to transmit the game packets, thereby leading to an increased latency.

As shown by reference number 704, a first ((N−1)th) uplink game packet may arrive at a first time. A UE may transmit the first uplink game packet via a PUSCH based at least in part on a smart BSR. The first uplink game packet may be associated with a first delay. A second ((N)th) uplink game packet may arrive at a second time. The UE may transmit the second uplink game packet via a PUSCH based at least in part on a smart BSR. The second uplink game packet may be associated with a second delay. A third ((N+1)th) uplink game packet may arrive at a third time. The UE may transmit the third uplink game packet via a PUSCH based at least in part on a smart BSR. In these cases, the game packets may arrive at any time, but the UE does not need to wait until a next available SR occasion before the UE is able to transmit the game packets. The UE may be able to transmit the uplink game packets almost immediately after they arrive, irrespective of the SR occasions, thereby reducing the latency.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with buffer status reporting for reduced uplink packet transmission latency.

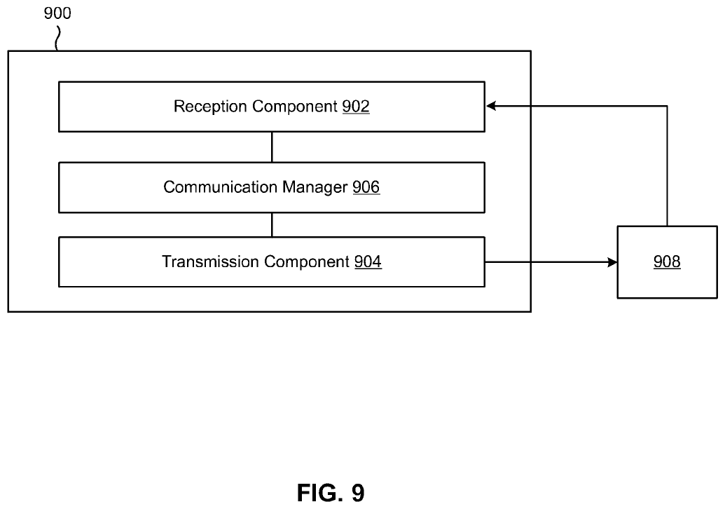

As shown in FIG. 8, in some aspects, process 800 may include determining that a smart BSR activation precondition is satisfied (block 810). For example, the UE (e.g., using communication manager 906, depicted in FIG. 9) may determine that a smart BSR activation precondition is satisfied, as described above.

As further shown in FIG. 8, in some aspects, process 800 may include setting an uplink traffic medium or high flag based at least in part on a quantity of arrived uplink packets in L2 (block 820). For example, the UE (e.g., using communication manager 906, depicted in FIG. 9) may set an uplink traffic medium or high flag based at least in part on a quantity of arrived uplink packets in L2, as described above.

As further shown in FIG. 8, in some aspects, process 800 may include setting a smart_BSR_active flag based at least in part on an average last SN latency in L2 and a padding bit ratio in L2 (block 830). For example, the UE (e.g., using communication manager 906, depicted in FIG. 9) may set a smart_BSR_active flag based at least in part on an average last SN latency in L2 and a padding bit ratio in L2, as described above.

As further shown in FIG. 8, in some aspects, process 800 may include detecting an uplink resource congestion based at least in part on the uplink traffic medium or high flag and the smart_BSR_active flag (block 840). For example, the UE (e.g., using communication manager 906, depicted in FIG. 9) may detect an uplink resource congestion based at least in part on the uplink traffic medium or high flag and the smart BSR active flag, as described above.

As further shown in FIG. 8, in some aspects, process 800 may include performing a slot BSR check by setting a slot BSR check flag, and a BSR index based at least in part on the slot BSR check flag, the uplink traffic medium or high flag, the smart BSR active flag, and a next available SR occasion, wherein the BSR index is associated with a slot level BSR activation check, and the BSR index is set according to an expected uplink packet size (block 850). For example, the UE (e.g., using communication manager 906, depicted in FIG. 9) may perform a slot BSR check by setting a slot BSR check flag, and a BSR index based at least in part on the slot BSR check flag, the uplink traffic medium or high flag, the smart BSR active flag, and a next available SR occasion, wherein the BSR index is associated with a slot level BSR activation check, and the BSR index is set according to an expected uplink packet size, as described above.

As further shown in FIG. 8, in some aspects, process 800 may include transmitting, to a network node and based at least in part on the slot BSR check, a BSR with the BSR index that indicates the expected uplink packet size (block 860). For example, the UE (e.g., using transmission component 904 and/or communication manager 906, depicted in FIG. 9) may transmit, to a network node and based at least in part on the slot BSR check, a BSR with the BSR index that indicates the expected uplink packet size, as described above.

As further shown in FIG. 8, in some aspects, process 800 may include transmitting, to the network node, an uplink packet associated with the expected uplink packet size based at least in part on the BSR (block 870). For example, the UE (e.g., using transmission component 904 and/or communication manager 906, depicted in FIG. 9) may transmit, to the network node, an uplink packet associated with the expected uplink packet size based at least in part on the BSR, as described above.

Process 800 may include additional aspects, such as any single aspect or any combination of aspects described below and/or in connection with one or more other processes described elsewhere herein.

In a first aspect, the smart BSR activation precondition is satisfied based at least in part on a low latency mode being enabled and a game accelerator being turned on, and the low latency mode and the game accelerator are associated with an application layer.

In a second aspect, alone or in combination with the first aspect, setting the uplink traffic medium or high flag comprises initializing the uplink traffic medium or high flag to false, counting the quantity of arrived uplink packets in L2 in a monitor window, setting the uplink traffic medium or high flag to true when the quantity of arrived uplink packets in L2 is greater than a first threshold, setting the uplink traffic medium or high flag to false when the quantity of arrived uplink packets in L2 is less than a second threshold in a quantity of consecutive monitor windows, and outputting the uplink traffic medium or high flag.

In a third aspect, alone or in combination with one or more of the first and second aspects, the quantity of arrived uplink packets L2 are associated with a gaming application.

In a fourth aspect, alone or in combination with one or more of the first through third aspects, setting the smart BSR active flag comprises initializing the smart BSR active flag to false, wherein the smart BSR active flag is associated with an ability to report additional buffer status information to the network node, determining the average last SN latency in L2 in a monitor window based at least in part on the uplink traffic medium or high flag and the smart BSR active flag, wherein the average last SN latency in L2 is updated in accordance with an update interval, determining the padding bit ratio in L2 in the monitor window based at least in part on the uplink traffic medium or high flag and the smart BSR active flag, wherein the padding bit ratio in L2 is updated in accordance with the update interval, determining one or more of whether the average last SN latency in L2 is greater than a last SN latency threshold, the padding bit ratio in L2 is less than a padding ratio threshold, or the padding bit ratio in L2 is less than a padding ratio limit, setting the smart BSR active flag to true when the average last SN latency in L2 is greater than the last SN latency threshold, the padding bit ratio in L2 is less than the padding ratio threshold, and the padding bit ratio in L2 is less than the padding ratio limit, setting the smart BSR active flag to false when one or more of the average last SN latency in L2 is not greater than the last SN latency threshold, the padding bit ratio in L2 is not less than the padding ratio threshold, or the padding bit ratio in L2 is not less than the padding ratio limit, and outputting the smart BSR active flag.

In a fifth aspect, alone or in combination with one or more of the first through fourth aspects, detecting the uplink resource congestion comprises setting the smart BSR active flag to false for a duration of time when the average last SN latency in L2 is less than an average last SN latency baseline plus a time period, and setting the smart BSR active flag to false when the average last SN latency in L2 is less than the average last SN latency baseline plus a time period in multiple instances.

In a sixth aspect, alone or in combination with one or more of the first through fifth aspects, performing the slot BSR check comprises initializing the slot BSR check flag to true, and setting the slot BSR check flag to false based at least in part on an uplink packet being sent, wherein no additional BSR index is sent when the slot BSR check flag is set to false.

In a seventh aspect, alone or in combination with one or more of the first through sixth aspects, performing the slot BSR check comprises identifying that the next available SR occasion occurs in less than a first time value, transmitting, for an expected uplink packet in accordance with an uplink packet distribution, an SR at the next available SR occasion nearest to the first time value, setting the slot BSR check flag to true after the SR is triggered, and setting the slot BSR check flag to false when the expected uplink packet is sent.

In an eighth aspect, alone or in combination with one or more of the first through seventh aspects, performing the slot BSR check comprises identifying that the next available SR occasion occurs in greater than a first time value and in less than a second time value, transmitting, for an expected uplink packet in accordance with an uplink packet distribution, an SR at the next available SR occasion nearest to the second time value, setting the slot BSR check flag to true after the SR is triggered, and setting the slot BSR check flag to false when the expected uplink packet is sent.

In a ninth aspect, alone or in combination with one or more of the first through eighth aspects, performing the slot BSR check comprises identifying that the next available SR occasion occurs in greater than a second time value and in less than a third time value, setting the slot BSR check flag to true for a first time period based at least in part on the next available SR occasion occurring in greater than the second time value and in less than the third time value, setting the slot BSR check flag to false when an uplink packet is sent during the first time period, transmitting, for an expected uplink packet in accordance with an uplink packet distribution, an SR at the next available SR occasion nearest to the third time value when the uplink packet is not sent, setting the slot BSR check flag to true after the SR is triggered, and setting the slot BSR check flag to false when the expected uplink packet is sent.

In a tenth aspect, alone or in combination with one or more of the first through ninth aspects, performing the slot BSR check comprises identifying that the next available SR occasion occurs in greater than a third time value and in less than a fourth time value, setting the slot BSR check flag to true for a first time period based at least in part on the next available SR occasion occurring in greater than the third time value and in less than the fourth time value, setting the slot BSR check flag to false when an uplink packet is sent during the first time period, transmitting, for an expected uplink packet in accordance with an uplink packet distribution, an SR at the next available SR occasion nearest to the third time value when the uplink packet is not sent, setting the slot BSR check flag to true after the SR is triggered, and setting the slot BSR check flag to false when the expected uplink packet is sent.

In an eleventh aspect, alone or in combination with one or more of the first through tenth aspects, performing the slot BSR check comprises identifying that the next available SR occasion occurs in greater than a fourth time value, setting the slot BSR check flag to true for a second time period based at least in part on the next available SR occasion that occurs in greater than the fourth time value, setting the slot BSR check flag to false when an uplink packet is sent during the second time period, triggering, for an expected uplink packet in accordance with an uplink packet distribution, an SR at the next available SR occasion when the uplink packet is not sent, setting the slot BSR check flag to true after the SR is triggered, and setting the slot BSR check flag to false when the expected uplink packet is sent.

In a twelfth aspect, alone or in combination with one or more of the first through eleventh aspects, the expected uplink packet size is an adaptive size that is based at least in part on a distribution of uplink packet size in L2 in a last time duration, and the expected uplink packet size does not exceed a defined limit.

In a thirteenth aspect, alone or in combination with one or more of the first through twelfth aspects, process 800 includes transmitting, to the network node, UAI to request additional uplink layers and a larger bandwidth based at least in part on an uplink grant size, wherein the UAI is transmitted based at least in part on a previous reduction in uplink layers, a UE sounding on one SRS port to induce one layer uplink grants, or a BWP associated with the UE that is less than a BWP threshold and one uplink layer being supported.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may determine that a smart BSR activation precondition is satisfied. The communication manager 906 may set an uplink traffic medium or high flag based at least in part on a quantity of arrived uplink packets in L2. The communication manager 906 may set a smart BSR active flag based at least in part on an average last SN latency in L2 and a padding bit ratio in L2. The communication manager 906 may detect an uplink resource congestion based at least in part on the uplink traffic medium or high flag and the smart BSR active flag. The communication manager 906 may perform a slot BSR check by setting a slot BSR check flag, and a BSR index based at least in part on the slot BSR check flag, the uplink traffic medium or high flag, the smart BSR active flag, and a next available SR occasion, wherein the BSR index is associated with a slot level BSR activation check, and the BSR index is set according to an expected uplink packet size. The transmission component 904 may transmit, to a network node and based at least in part on the slot BSR check, a BSR with the BSR index that indicates the expected uplink packet size. The transmission component 904 may transmit, to the network node, an uplink packet associated with the expected uplink packet size based at least in part on the BSR.

The communication manager 906 may initialize the uplink traffic medium or high flag to false. The communication manager 906 may count the quantity of arrived uplink packets in L2 in a monitor window. The communication manager 906 may set the uplink traffic medium or high flag to true when the quantity of arrived uplink packets in L2 is greater than a first threshold. The communication manager 906 may set the uplink traffic medium or high flag to false when the quantity of arrived uplink packets in L2 is less than a second threshold in a quantity of consecutive monitor windows. The communication manager 906 may output the uplink traffic medium or high flag.

The communication manager 906 may initialize the smart BSR active flag to false, wherein the smart BSR active flag is associated with an ability to report additional buffer status information to the network node. The communication manager 906 may determine the average last SN latency in L2 in a monitor window based at least in part on the uplink traffic medium or high flag and the smart BSR active flag, wherein the average last SN latency in L2 is updated in accordance with an update interval. The communication manager 906 may determine the padding bit ratio in L2 in the monitor window based at least in part on the uplink traffic medium or high flag and the smart BSR active flag, wherein the padding bit ratio in L2 is updated in accordance with the update interval. The communication manager 906 may determine one or more of whether the average last SN latency in L2 is greater than a last SN latency threshold, the padding bit ratio in L2 is less than a padding ratio threshold, or the padding bit ratio in L2 is less than a padding ratio limit. The communication manager 906 may set the smart BSR active flag to true when the average last SN latency in L2 is greater than the last SN latency threshold, the padding bit ratio in L2 is less than the padding ratio threshold, and the padding bit ratio in L2 is less than the padding ratio limit. The communication manager 906 may set the smart BSR active flag to false when one or more of: the average last SN latency in L2 is not greater than the last SN latency threshold, the padding bit ratio in L2 is not less than the padding ratio threshold, or the padding bit ratio in L2 is not less than the padding ratio limit. The communication manager 906 may output the smart BSR active flag.

The communication manager 906 may set the smart BSR active flag to false for a duration of time when the average last SN latency in L2 is less than an average last SN latency baseline plus a time period. The communication manager 906 may set the smart BSR active flag to false when the average last SN latency in L2 is less than the average last SN latency baseline plus a time period in multiple instances.

The communication manager 906 may initialize the slot BSR check flag to true. The communication manager 906 may set the slot BSR check flag to false based at least in part on an uplink packet being sent, wherein no additional BSR index is sent when the slot BSR check flag is set to false.

The communication manager 906 may identify that the next available SR occasion occurs in less than a first time value. The transmission component 904 may transmit, for an expected uplink packet in accordance with an uplink packet distribution, an SR at the next available SR occasion nearest to the first time value. The communication manager 906 may set the slot BSR check flag to true after the SR is triggered. The communication manager 906 may set the slot BSR check flag to false when the expected uplink packet is sent.

The communication manager 906 may identify that the next available SR occasion occurs in greater than a first time value and in less than a second time value. The transmission component 904 may transmit, for an expected uplink packet in accordance with an uplink packet distribution, an SR at the next available SR occasion nearest to the second time value. The communication manager 906 may set the slot BSR check flag to true after the SR is triggered. The communication manager 906 may set the slot BSR check flag to false when the expected uplink packet is sent.

The communication manager 906 may identify that the next available SR occasion occurs in greater than a second time value and in less than a third time value. The communication manager 906 may set the slot BSR check flag to true for a first time period based at least in part on the next available SR occasion occurring in greater than the second time value and in less than the third time value. The communication manager 906 may set the slot BSR check flag to false when an uplink packet is sent during the first time period. The transmission component 904 may transmit, for an expected uplink packet in accordance with an uplink packet distribution, an SR at the next available SR occasion nearest to the third time value when the uplink packet is not sent. The communication manager 906 may set the slot BSR check flag to true after the SR is triggered. The communication manager 906 may set the slot BSR check flag to false when the expected uplink packet is sent.

The communication manager 906 may identify that the next available SR occasion occurs in greater than a third time value and in less than a fourth time value. The communication manager 906 may set the slot BSR check flag to true for a first time period based at least in part on the next available SR occasion occurring in greater than the third time value and in less than the fourth time value. The communication manager 906 may set the slot BSR check flag to false when an uplink packet is sent during the first time period. The transmission component 904 may transmit, for an expected uplink packet in accordance with an uplink packet distribution, an SR at the next available SR occasion nearest to the third time value when the uplink packet is not sent. The communication manager 906 may set the slot BSR check flag to true after the SR is triggered. The communication manager 906 may set the slot BSR check flag to false when the expected uplink packet is sent.

The communication manager 906 may identify that the next available SR occasion occurs in greater than a fourth time value. The communication manager 906 may set the slot BSR check flag to true for a second time period based at least in part on the next available SR occasion that occurs in greater than the fourth time value. The communication manager 906 may set the slot BSR check flag to false when an uplink packet is sent during the second time period. The communication manager 906 may trigger, for an expected uplink packet in accordance with an uplink packet distribution, an SR at the next available SR occasion when the uplink packet is not sent. The communication manager 906 may set the slot BSR check flag to true after the SR is triggered. The communication manager 906 may set the slot BSR check flag to false when the expected uplink packet is sent.

The transmission component 904 may transmit, to the network node, UAI to request additional uplink layers and a larger bandwidth based at least in part on an uplink grant size, wherein the UAI is transmitted based at least in part on a previous reduction in uplink layers, a UE sounding on one SRS port to induce one layer uplink grants, or a BWP associated with the UE that is less than a BWP threshold and one uplink layer being supported.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: determining, by the UE, that a smart buffer status report (BSR) activation precondition is satisfied; setting, by the UE, an uplink traffic medium or high flag based at least in part on a quantity of arrived uplink packets in layer 2 (L2); setting, by the UE, a smart BSR active flag based at least in part on an average last sequence number (SN) latency in L2 and a padding bit ratio in L2; detecting, by the UE, an uplink resource congestion based at least in part on the uplink traffic medium or high flag and the smart BSR active flag; performing, by the UE, a slot BSR check by setting a slot BSR check flag, and a BSR index based at least in part on the slot BSR check flag, the uplink traffic medium or high flag, the smart BSR active flag, and a next available scheduling request (SR) occasion, wherein the BSR index is associated with a slot level BSR activation check, and the BSR index is set according to an expected uplink packet size; transmitting, to a network node and based at least in part on the slot BSR check, a BSR with the BSR index that indicates the expected uplink packet size; and transmitting, to the network node, an uplink packet associated with the expected uplink packet size based at least in part on the BSR.
Aspect 2: The method of Aspect 1, wherein the smart BSR activation precondition is satisfied based at least in part on a low latency mode being enabled and a game accelerator being turned on, and wherein the low latency mode and the game accelerator are associated with an application layer.
Aspect 3: The method of any of Aspects 1-2, wherein setting the uplink traffic medium or high flag comprises: initializing the uplink traffic medium or high flag to false; counting the quantity of arrived uplink packets in L2 in a monitor window; setting the uplink traffic medium or high flag to true when the quantity of arrived uplink packets in L2 is greater than a first threshold; setting the uplink traffic medium or high flag to false when the quantity of arrived uplink packets in L2 is less than a second threshold in a quantity of consecutive monitor windows; and outputting the uplink traffic medium or high flag.
Aspect 4: The method of any of Aspects 1-3, wherein the quantity of arrived uplink packets L2 are associated with a gaming application.
Aspect 5: The method of any of Aspects 1-4, wherein setting the smart BSR active flag comprises: initializing the smart BSR active flag to false, wherein the smart BSR active flag is associated with an ability to report additional buffer status information to the network node; determining the average last SN latency in L2 in a monitor window based at least in part on the uplink traffic medium or high flag and the smart BSR active flag, wherein the average last SN latency in L2 is updated in accordance with an update interval; determining the padding bit ratio in L2 in the monitor window based at least in part on the uplink traffic medium or high flag and the smart BSR active flag, wherein the padding bit ratio in L2 is updated in accordance with the update interval; determining one or more of whether the average last SN latency in L2 is greater than a last SN latency threshold, the padding bit ratio in L2 is less than a padding ratio threshold, or the padding bit ratio in L2 is less than a padding ratio limit; setting the smart BSR active flag to true when the average last SN latency in L2 is greater than the last SN latency threshold, the padding bit ratio in L2 is less than the padding ratio threshold, and the padding bit ratio in L2 is less than the padding ratio limit; setting the smart BSR active flag to false when one or more of: the average last SN latency in L2 is not greater than the last SN latency threshold, the padding bit ratio in L2 is not less than the padding ratio threshold, or the padding bit ratio in L2 is not less than the padding ratio limit; and outputting the smart BSR active flag.
Aspect 6: The method of Aspect 5, wherein detecting the uplink resource congestion comprises: setting the smart BSR active flag to false for a duration of time when the average last SN latency in L2 is less than an average last SN latency baseline plus a time period; and setting the smart BSR active flag to false when the average last SN latency in L2 is less than the average last SN latency baseline plus a time period in multiple instances.
Aspect 7: The method of any of Aspects 1-6, wherein performing the slot BSR check comprises: initializing the slot BSR check flag to true; and setting the slot BSR check flag to false based at least in part on an uplink packet being sent, wherein no additional BSR index is sent when the slot BSR check flag is set to false.
Aspect 8: The method of Aspect 7, wherein performing the slot BSR check comprises: identifying that the next available SR occasion occurs in less than a first time value; transmitting, for an expected uplink packet in accordance with an uplink packet distribution, an SR at the next available SR occasion nearest to the first time value; setting the slot BSR check flag to true after the SR is triggered; and setting the slot BSR check flag to false when the expected uplink packet is sent.
Aspect 9: The method of Aspect 7, wherein performing the slot BSR check comprises: identifying that the next available SR occasion occurs in greater than a first time value and in less than a second time value; transmitting, for an expected uplink packet in accordance with an uplink packet distribution, an SR at the next available SR occasion nearest to the second time value; setting the slot BSR check flag to true after the SR is triggered; and setting the slot BSR check flag to false when the expected uplink packet is sent.
Aspect 10: The method of Aspect 7, wherein performing the slot BSR check comprises: identifying that the next available SR occasion occurs in greater than a second time value and in less than a third time value; setting the slot BSR check flag to true for a first time period based at least in part on the next available SR occasion occurring in greater than the second time value and in less than the third time value; setting the slot BSR check flag to false when an uplink packet is sent during the first time period; transmitting, for an expected uplink packet in accordance with an uplink packet distribution, an SR at the next available SR occasion nearest to the third time value when the uplink packet is not sent; setting the slot BSR check flag to true after the SR is triggered; and setting the slot BSR check flag to false when the expected uplink packet is sent.
Aspect 11: The method of Aspect 7, wherein performing the slot BSR check comprises: identifying that the next available SR occasion occurs in greater than a third time value and in less than a fourth time value; setting the slot BSR check flag to true for a first time period based at least in part on the next available SR occasion occurring in greater than the third time value and in less than the fourth time value; setting the slot BSR check flag to false when an uplink packet is sent during the first time period; transmitting, for an expected uplink packet in accordance with an uplink packet distribution, an SR at the next available SR occasion nearest to the third time value when the uplink packet is not sent; setting the slot BSR check flag to true after the SR is triggered; and setting the slot BSR check flag to false when the expected uplink packet is sent.
Aspect 12: The method of Aspect 7, wherein performing the slot BSR check comprises: identifying that the next available SR occasion occurs in greater than a fourth time value; setting the slot BSR check flag to true for a second time period based at least in part on the next available SR occasion that occurs in greater than the fourth time value; setting the slot BSR check flag to false when an uplink packet is sent during the second time period; triggering, for an expected uplink packet in accordance with an uplink packet distribution, an SR at the next available SR occasion when the uplink packet is not sent; setting the slot BSR check flag to true after the SR is triggered; and setting the slot BSR check flag to false when the expected uplink packet is sent.
Aspect 13: The method of any of Aspects 1-12, wherein the expected uplink packet size is an adaptive size that is based at least in part on a distribution of uplink packet size in L2 in a last time duration, and wherein the expected uplink packet size does not exceed a defined limit.
Aspect 14: The method of any of Aspects 1-13, further comprising: transmitting, to the network node, UE assistance information (UAI) to request additional uplink layers and a larger bandwidth based at least in part on an uplink grant size, wherein the UAI is transmitted based at least in part on a previous reduction in uplink layers, a UE sounding on one sounding reference signal (SRS) port to induce one layer uplink grants, or a bandwidth part (BWP) associated with the UE that is less than a BWP threshold and one uplink layer being supported.
Aspect 15: An apparatus for wireless communication at a device, comprising a processor; memory coupled with the processor; and instructions stored in the memory and executable by the processor to cause the apparatus to perform the method of one or more of Aspects 1-14.
Aspect 16: A device for wireless communication, comprising a memory and one or more processors coupled to the memory, the one or more processors configured to perform the method of one or more of Aspects 1-14.
Aspect 17: An apparatus for wireless communication, comprising at least one means for performing the method of one or more of Aspects 1-14.
Aspect 18: A non-transitory computer-readable medium storing code for wireless communication, the code comprising instructions executable by a processor to perform the method of one or more of Aspects 1-14.
Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
determine, by the UE, that a smart buffer status report (BSR) activation precondition is satisfied;
set, by the UE, an uplink traffic medium or high flag based at least in part on a quantity of arrived uplink packets in layer 2 (L2);
set, by the UE, a smart BSR active flag based at least in part on an average last sequence number (SN) latency in L2 and a padding bit ratio in L2;
detect, by the UE, an uplink resource congestion based at least in part on the uplink traffic medium or high flag and the smart BSR active flag;
perform, by the UE, a slot BSR check by setting a slot BSR check flag, and a BSR index based at least in part on the slot BSR check flag, the uplink traffic medium or high flag, the smart BSR active flag, and a next available scheduling request (SR) occasion, wherein the BSR index is associated with a slot level BSR activation check, and the BSR index is set according to an expected uplink packet size;
transmit, to a network node and based at least in part on the slot BSR check, a BSR with the BSR index that indicates the expected uplink packet size; and
transmit, to the network node, an uplink packet associated with the expected uplink packet size based at least in part on the BSR.

2. The apparatus of claim 1, wherein the smart BSR activation precondition is satisfied based at least in part on a low latency mode being enabled and a game accelerator being turned on, and wherein the low latency mode and the game accelerator are associated with an application layer.

3. The apparatus of claim 1, wherein the one or more processors, to set the uplink traffic medium or high flag, are configured to:
initialize the uplink traffic medium or high flag to false;
count the quantity of arrived uplink packets in L2 in a monitor window;
set the uplink traffic medium or high flag to true when the quantity of arrived uplink packets in L2 is greater than a first threshold;
set the uplink traffic medium or high flag to false when the quantity of arrived uplink packets in L2 is less than a second threshold in a quantity of consecutive monitor windows; and
output the uplink traffic medium or high flag.

4. (canceled)

5. The apparatus of claim 1, wherein the one or more processors, to set the smart BSR active flag, are configured to:
initialize the smart BSR active flag to false, wherein the smart BSR active flag is associated with an ability to report additional buffer status information to the network node;
determine the average last SN latency in L2 in a monitor window based at least in part on the uplink traffic medium or high flag and the smart BSR active flag, wherein the average last SN latency in L2 is updated in accordance with an update interval;
determine the padding bit ratio in L2 in the monitor window based at least in part on the uplink traffic medium or high flag and the smart BSR active flag, wherein the padding bit ratio in L2 is updated in accordance with the update interval;
determine one or more of whether the average last SN latency in L2 is greater than a last SN latency threshold, the padding bit ratio in L2 is less than a padding ratio threshold, or the padding bit ratio in L2 is less than a padding ratio limit;
set the smart BSR active flag to true when the average last SN latency in L2 is greater than the last SN latency threshold, the padding bit ratio in L2 is less than the padding ratio threshold, and the padding bit ratio in L2 is less than the padding ratio limit;
set the smart BSR active flag to false when one or more of: the average last SN latency in L2 is not greater than the last SN latency threshold, the padding bit ratio in L2 is not less than the padding ratio threshold, or the padding bit ratio in L2 is not less than the padding ratio limit; and
output the smart BSR active flag.

6. The apparatus of claim 5, wherein the one or more processors, to detect the uplink resource congestion, are configured to:
set the smart BSR active flag to false for a duration of time when the average last SN latency in L2 is less than an average last SN latency baseline plus a time period; and
set the smart BSR active flag to false when the average last SN latency in L2 is less than the average last SN latency baseline plus a time period in multiple instances.

7. The apparatus of claim 1, wherein the one or more processors, to perform the slot BSR check, are configured to:
initialize the slot BSR check flag to true; and
set the slot BSR check flag to false based at least in part on an uplink packet being sent, wherein no additional BSR index is sent when the slot BSR check flag is set to false.

8. The apparatus of claim 7, wherein the one or more processors, to perform the slot BSR check, are configured to:
identify that the next available SR occasion occurs in less than a first time value;
transmit, for an expected uplink packet in accordance with an uplink packet distribution, an SR at the next available SR occasion nearest to the first time value;
set the slot BSR check flag to true after the SR is triggered; and
set the slot BSR check flag to false when the expected uplink packet is sent.

9. The apparatus of claim 7, wherein the one or more processors, to perform the slot BSR check, are configured to:
identify that the next available SR occasion occurs in greater than a first time value and in less than a second time value;
transmit, for an expected uplink packet in accordance with an uplink packet distribution, an SR at the next available SR occasion nearest to the second time value;
set the slot BSR check flag to true after the SR is triggered; and
set the slot BSR check flag to false when the expected uplink packet is sent.

10. The apparatus of claim 7, wherein the one or more processors, to perform the slot BSR check, are configured to:
identify that the next available SR occasion occurs in greater than a second time value and in less than a third time value;
set the slot BSR check flag to true for a first time period based at least in part on the next available SR occasion occurring in greater than the second time value and in less than the third time value;
set the slot BSR check flag to false when an uplink packet is sent during the first time period;
transmit, for an expected uplink packet in accordance with an uplink packet distribution, an SR at the next available SR occasion nearest to the third time value when the uplink packet is not sent;
set the slot BSR check flag to true after the SR is triggered; and
set the slot BSR check flag to false when the expected uplink packet is sent.

11. The apparatus of claim 7, wherein the one or more processors, to perform the slot BSR check, are configured to:
identify that the next available SR occasion occurs in greater than a third time value and in less than a fourth time value;
set the slot BSR check flag to true for a first time period based at least in part on the next available SR occasion occurring in greater than the third time value and in less than the fourth time value;
set the slot BSR check flag to false when an uplink packet is sent during the first time period;
transmit, for an expected uplink packet in accordance with an uplink packet distribution, an SR at the next available SR occasion nearest to the third time value when the uplink packet is not sent;
set the slot BSR check flag to true after the SR is triggered; and
set the slot BSR check flag to false when the expected uplink packet is sent.

12. The apparatus of claim 7, wherein the one or more processors, to perform the slot BSR check, are configured to:
identify that the next available SR occasion occurs in greater than a fourth time value;
set the slot BSR check flag to true for a second time period based at least in part on the next available SR occasion that occurs in greater than the fourth time value;
set the slot BSR check flag to false when an uplink packet is sent during the second time period;
trigger, for an expected uplink packet in accordance with an uplink packet distribution, an SR at the next available SR occasion when the uplink packet is not sent;
set the slot BSR check flag to true after the SR is triggered; and
set the slot BSR check flag to false when the expected uplink packet is sent.

13-14. (canceled)

15. A method of wireless communication performed by a user equipment (UE), comprising:
determining, by the UE, that a smart buffer status report (BSR) activation precondition is satisfied;
setting, by the UE, an uplink traffic medium or high flag based at least in part on a quantity of arrived uplink packets in layer 2 (L2);
setting, by the UE, a smart BSR active flag based at least in part on an average last sequence number (SN) latency in L2 and a padding bit ratio in L2;
detecting, by the UE, an uplink resource congestion based at least in part on the uplink traffic medium or high flag and the smart BSR active flag;
performing, by the UE, a slot BSR check by setting a slot BSR check flag, and a BSR index based at least in part on the slot BSR check flag, the uplink traffic medium or high flag, the smart BSR active flag, and a next available scheduling request (SR) occasion, wherein the BSR index is associated with a slot level BSR activation check, and the BSR index is set according to an expected uplink packet size;
transmitting, to a network node and based at least in part on the slot BSR check, a BSR with the BSR index that indicates the expected uplink packet size; and
transmitting, to the network node, an uplink packet associated with the expected uplink packet size based at least in part on the BSR.

16. (canceled)

17. The method of claim 15, wherein setting the uplink traffic medium or high flag comprises:
initializing the uplink traffic medium or high flag to false;
counting the quantity of arrived uplink packets in L2 in a monitor window;
setting the uplink traffic medium or high flag to true when the quantity of arrived uplink packets in L2 is greater than a first threshold;
setting the uplink traffic medium or high flag to false when the quantity of arrived uplink packets in L2 is less than a second threshold in a quantity of consecutive monitor windows; and
outputting the uplink traffic medium or high flag.

18. (canceled)

19. The method of claim 15, wherein setting the smart BSR active flag comprises:
initializing the smart BSR active flag to false, wherein the smart BSR active flag is associated with an ability to report additional buffer status information to the network node;
determining the average last SN latency in L2 in a monitor window based at least in part on the uplink traffic medium or high flag and the smart BSR active flag, wherein the average last SN latency in L2 is updated in accordance with an update interval;
determining the padding bit ratio in L2 in the monitor window based at least in part on the uplink traffic medium or high flag and the smart BSR active flag, wherein the padding bit ratio in L2 is updated in accordance with the update interval;
determining one or more of whether the average last SN latency in L2 is greater than a last SN latency threshold, the padding bit ratio in L2 is less than a padding ratio threshold, or the padding bit ratio in L2 is less than a padding ratio limit;
setting the smart BSR active flag to true when the average last SN latency in L2 is greater than the last SN latency threshold, the padding bit ratio in L2 is less than the padding ratio threshold, and the padding bit ratio in L2 is less than the padding ratio limit;
setting the smart BSR active flag to false when one or more of: the average last SN latency in L2 is not greater than the last SN latency threshold, the padding bit ratio in L2 is not less than the padding ratio threshold, or the padding bit ratio in L2 is not less than the padding ratio limit; and
outputting the smart BSR active flag.

20. (canceled)

21. The method of claim 15, wherein performing the slot BSR check comprises:
initializing the slot BSR check flag to true; and
setting the slot BSR check flag to false based at least in part on an uplink packet being sent, wherein no additional BSR index is sent when the slot BSR check flag is set to false.

22-24. (canceled)

25. The method of claim 21, wherein performing the slot BSR check comprises:
identifying that the next available SR occasion occurs in greater than a third time value and in less than a fourth time value;
setting the slot BSR check flag to true for a first time period based at least in part on the next available SR occasion occurring in greater than the third time value and in less than the fourth time value;
setting the slot BSR check flag to false when an uplink packet is sent during the first time period;
transmitting, for an expected uplink packet in accordance with an uplink packet distribution, an SR at the next available SR occasion nearest to the third time value when the uplink packet is not sent;
setting the slot BSR check flag to true after the SR is triggered; and
setting the slot BSR check flag to false when the expected uplink packet is sent.

26. The method of claim 21, wherein performing the slot BSR check comprises:
identifying that the next available SR occasion occurs in greater than a fourth time value;
setting the slot BSR check flag to true for a second time period based at least in part on the next available SR occasion that occurs in greater than the fourth time value;
setting the slot BSR check flag to false when an uplink packet is sent during the second time period;
triggering, for an expected uplink packet in accordance with an uplink packet distribution, an SR at the next available SR occasion when the uplink packet is not sent;
setting the slot BSR check flag to true after the SR is triggered; and
setting the slot BSR check flag to false when the expected uplink packet is sent.

27. The method of claim 15, wherein the expected uplink packet size is an adaptive size that is based at least in part on a distribution of uplink packet size in L2 in a last time duration, and wherein the expected uplink packet size does not exceed a defined limit.

28. The method of claim 15, further comprising:
transmitting, to the network node, UE assistance information (UAI) to request additional uplink layers and a larger bandwidth based at least in part on an uplink grant size, wherein the UAI is transmitted based at least in part on a previous reduction in uplink layers, a UE sounding on one sounding reference signal (SRS) port to induce one layer uplink grants, or a bandwidth part (BWP) associated with the UE that is less than a BWP threshold and one uplink layer being supported.

29. (canceled)

30. An apparatus for wireless communication, comprising:
means for determining that a smart buffer status report (BSR) activation precondition is satisfied;
means for setting an uplink traffic medium or high flag based at least in part on a quantity of arrived uplink packets in layer 2 (L2);
means for setting a smart BSR active flag based at least in part on an average last sequence number (SN) latency in L2 and a padding bit ratio in L2;
means for detecting an uplink resource congestion based at least in part on the uplink traffic medium or high flag and the smart BSR active flag;
means for performing a slot BSR check by setting a slot BSR check flag, and a BSR index based at least in part on the slot BSR check flag, the uplink traffic medium or high flag, the smart BSR active flag, and a next available scheduling request (SR) occasion, wherein the BSR index is associated with a slot level BSR activation check, and the BSR index is set according to an expected uplink packet size;
means for transmitting, to a network node and based at least in part on the slot BSR check, a BSR with the BSR index that indicates the expected uplink packet size; and
means for transmitting, to the network node, an uplink packet associated with the expected uplink packet size based at least in part on the BSR.
